(19) United States
(12) Patent Application Publication
(10) Pub. No.: US 2022/0355707 A1
(43) Pub. Date: Nov. 10, 2022

(54) Vehicle with Enhanced Entertainment and Storage Options

(71) Applicant: Thomas McDonald, Hamlet, NC (US)

(72) Inventor: Thomas McDonald, Hamlet, NC (US)

(21) Appl. No.: 17/314,207

(22) Filed: May 7, 2021

(51) Int. Cl. B60N 2/01; B60R 7/04; B60R 11/02

(52) U.S. Cl. CPC B60N 2/01; B60R 7/043; B60R 11/0229

(57) ABSTRACT

A family sized vehicle or car with enhanced entertainment and storage options is disclosed. The vehicle or car of the present invention offers a family functionality, comfort, and style when traveling, especially when traveling long distances with children. The vehicle or car of the present invention includes three rows of seats, having two seats in each of the first and second rows, and four seats connected and arc-positioned in a rear third row. The novel vehicle of the present invention also includes two hidden compartments for the storage of personal items, a relatively deep trunk storage area for luggage, suicide doors, a moonroof and two nine-inch televisions for entertainment.

### FIELD OF THE INVENTION

The present invention relates generally to the field of motor vehicles. More specifically, the present invention relates to a fun, family-friendly sports car that includes a variety of comfort and entertainment features, and offers a family functionality, comfort and style when traveling, especially long distances. The family fun sports vehicle includes improved seats, hidden storage compartments, doors that are hinged at the rear of the vehicle instead of the front (i.e., “suicide doors”), a moon roof, televisions and other features that are designed to provide comfort to the users during travel. Accordingly, the present disclosure makes specific reference thereto. Nonetheless, it is to be appreciated that aspects of the present invention are also equally applicable to other like applications, vehicles and transport means.

### BACKGROUND OF THE INVENTION

By the way of background, families often take long road trips, such as when driving to a vacation destination. People may travel to the destination by public transportation or by their private vehicles. Usually, people taking road trips with their family prefer traveling in private vehicles to ensure privacy and comfort throughout the journey to their destination. Various vehicles are available in the state of the art that allow individuals and families to take road trips. However, none of the available vehicle designs completely fulfil the entertainment and comfort needs of today's passengers.

Currently available automobiles and other vehicles feature advanced systems for ease of travel, saving time, transporting cargo, safety, and many more features. However, when families take long road trips, family members may get bored and uncomfortable due to the lack of sufficient entertainment options within the vehicle. This is especially true for children who get bored easily and irritated traveling in a vehicle on long road trips. Parents and elderly passengers may become overwhelmed and frustrated by children who are bored and irritated as well. This situation can lead to an unenjoyable experience for everyone inside of the vehicle.

While most current automobile designs focus on the safety of the people travelling in the car, such vehicles lack any entertainment or amusement for the passengers, which along with the confinement of young children or even teenagers, may cause boredom, anger, temper tantrums, crying, whining and the like, much to the dismay of the parents or elderly family members in the vehicle. A suitable solution is desired.

Currently, there exist some prior art examples that have led to modest improvements in providing entertainment features while traveling in a vehicle with family, children or friends. One prior art design is an amusement system for a car seat having speakers, audio sources and an anti-noise audio system. Another prior art design is a seat with a compartment for carrying an audio source and more. While these prior art designs fulfilled specific objectives, they failed to provide an overall entertainment experience for the user.

Additionally, families taking an extended vacation need to bring a multitude of items from home including clothing, shoes, coats, toiletries, etc., thus leading to a large amount of luggage. Usually, cars have a trunk storage compartment that is only designed to hold enough luggage for three to four people. When traveling together with the family in conventional vehicles, luggage space for more than four people is scarce due to lack of storage compartments.

Therefore, there exists a long felt need in the art for a vehicle specially designed and manufactured to take into account the needs and requirements of its passengers. There also exists a long felt need in the art for a vehicle design that includes multiple features for providing fun and entertainment for the vehicle passengers, and wherein the entertainment features are easily accessible to those passengers located in the middle and rear seats. Additionally, there is a long felt need in the art for a vehicle that can make long distance traveling both fun and entertaining, and that has sufficient storage compartments to store luggage for more than four passengers. Furthermore, there is a long felt need in the art for a vehicle that enables all passengers, including the elderly and small children, to enjoy long road trips while still maintaining their own privacy and comfort zone. Finally, there is a long felt need in the art for a vehicle that is relatively inexpensive to manufacture and that is both safe and easy to use.

The subject matter disclosed and claimed herein, in one embodiment thereof, comprises a family sized vehicle or car that includes a plurality of easy to operate comfort, storage and entertainment features. The vehicle or car of the present invention offers a family functionality, comfort, and style when traveling, especially when traveling long distances with children. The vehicle or car of the present invention includes three rows of seats, having two seats in each of the first and second rows, and four seats connected and arc-positioned in a rear third row. The novel vehicle of the present invention also includes two hidden compartments for the storage of personal items, a relatively deep trunk storage area for luggage, suicide doors, a moon roof and two nine-inch televisions for entertainment.

In this manner, the vehicle with enhanced entertainment and storage options of the present invention accomplishes all of the forgoing objectives, while providing a fun travel experience for a group of friends or family members on long road trips to, for example, a vacation destination. The vehicle is designed with a variety of comfort and entertainment features that can be easily reached and operated by all passengers, thereby making the long journey a fun-filled experience. Additionally, the vehicle provides full enjoyment for all the passengers, including adults and children, during travel to their destination.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a family-sized vehicle featuring three rows of seats, a first hidden compartment located between the second row of seats, a second hidden compartment between the third row of seats, two television units, a relatively deep trunk, a moon roof, a dashboard and a plurality of suicide doors. The vehicle of the present invention is configured to provide comfort and style to all of the passengers, not just those in the first row. The first row includes a driver seat and a passenger seat, the second row includes a set of mid-passenger seats and a hidden compartment located in the middle of the same, and the third row includes four interconnected seats in a slighted rotated or arc-like arrangement, and a second hidden compartment positioned between two of said third row seats. In one embodiment of the present invention, the dashboard includes an entertainment unit along with the other driving-specific instruments, such as a speedometer/odometer, gas gauge and attention lights.

The present invention provides a family-sized car or vehicle with entertainment features that are easily accessible to those passengers who are located in the second and third rows of seats. The vehicle of the present invention also provides users with an integrated, advanced system that provides multiple simultaneous amusement activities for the enjoyment of all passengers. The novel vehicle design makes it very convenient for the users to take long rides while performing multiple enjoyable activities. The family-sized car or vehicle of the present invention may also include additional features, such as vibration and heating/cooling within the seats to provide a soothing effect, illuminating lights that can be used to entertain, and power supply connections that can be used to power various mobile electronic devices.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top perspective view of one potential embodiment of the interior layout of the vehicle with enhanced entertainment and storage options of the present invention in accordance with the disclosed architecture;

FIG. 2 illustrates a top perspective view of another potential embodiment of the vehicle with enhanced entertainment and storage options of the present invention in accordance with the disclosed architecture, wherein the vehicle is comprised of a moonroof and a plurality of rear hinged or “suicide” doors;

FIG. 3 illustrates a perspective view of one potential embodiment of the interior dashboard of the vehicle with enhanced entertainment and storage options of the present invention in accordance with the disclosed architecture; and

FIG. 4 illustrates a diagrammatic view of one potential embodiment of the electronic components of the entertainment system of the vehicle with enhanced entertainment and storage options of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a vehicle with enhanced entertainment and storage options that is specially designed and manufactured to take into account the needs and requirements of all of its passengers. There also exists a long felt need in the art for a vehicle design that includes multiple features for providing fun and entertainment to the vehicle passengers, and wherein the entertainment features are easily accessible to those passengers located in the middle and rear seats. Additionally, there is a long felt need in the art for a vehicle that can make long distance traveling both entertaining and enjoyable, and that has sufficient storage compartments to store luggage for more than four passengers. Furthermore, there is a long felt need in the art for a vehicle that enables all passengers, including the elderly and small children, to enjoy long road trips while still maintaining their own privacy and comfort zone. Finally, there is a long felt need in the art for a vehicle that is relatively inexpensive to manufacture and that is both safe and easy to use.

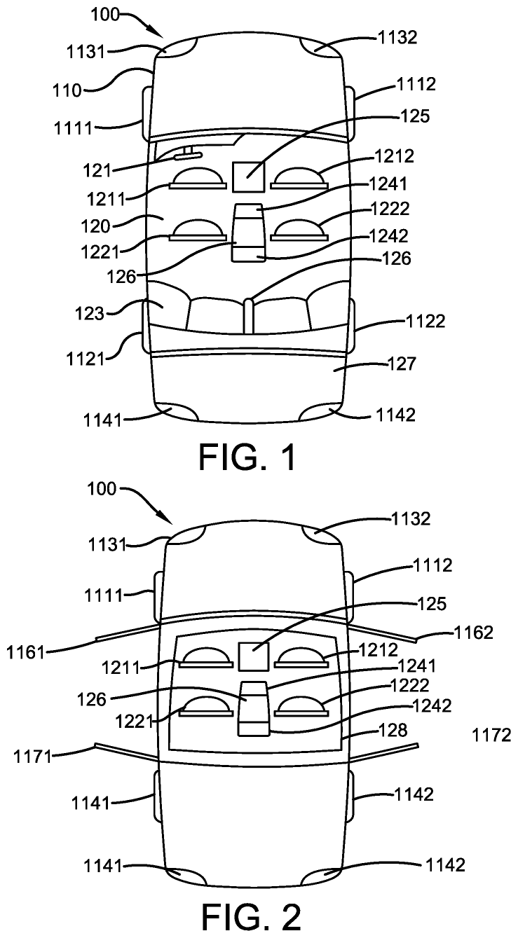

Referring initially to the drawings, FIG. 1 illustrates a top perspective view of one potential embodiment of the interior layout of the vehicle 100 with enhanced entertainment and storage options of the present invention in accordance with the disclosed architecture. The vehicle 100 of the present invention is comprised of a car body 110 for providing the mechanical structure of the vehicle 100 and an interior space of the car 120 to accommodate users and other components providing comfort and entertainment to the passengers. The car body 110 further comprises four tires including a front left tire 1111, a front right tire 1112, a rear left tire 1121 and rear right tire 1122, two front safety lights to help prevent accidents during nighttime driving, including a front left light 1131 and a front right light 1132, two turn-signal indicators including a rear left indicator 1141 and a rear right indicator 1142, and four doors including at least two suicide doors.

The tires 1111, 1112, 1121, 1122 of the vehicle 100 are generally comprised of rubber. Nonetheless, other materials may also be used to manufacture a robust tire as per the desires of the users and manufacturers. The tires 1111, 1112, 1121, 1122 may have a tube or may be tubeless as per the requirements of the users. The engine, drive train and other components of the vehicle 100 not specifically described herein are substantially similar to other vehicles known in the art and therefore are not further discussed herein.

The car body 110 is made up of a suitable material or combination of different materials selected from a steel or stainless-steel material, a fiber reinforced composite material, an ABS plastic, an aluminum alloy, a magnesium alloy, a carbon fiber reinforced plastic or any other suitable and durable material. The car body 110 should be strong enough to withstand the mechanical loads and impacts that automobiles and other vehicles are commonly subjected to, and may also comprise commercially available safety features such as, but not limited to, safety belts and deployable air bags.

The interior space of the car body 120 comprises a steering wheel 121 to provide direction for the vehicle 100, and a first, second and third or rear row of seats. The first row of seats comprises a driver seat 1211 and a front passenger seat 1212. The second row seats comprises a mid-passenger left seat 1221 and a mid-passenger right seat 1222. The third or rear row of seats comprises a rear passenger seat 123 having a bench-style seating arrangement sized for four passengers whereby each of the passenger seats are interconnected and positioned such that they form a slight inward arc to allow each of the four passengers to see and talk to each other without having to turn sideways on their seat.

As previously noted, the vehicle 100 further comprises two nine-inch televisions for the entertainment of the passengers while traveling. A first 9-inch TV 1241 is positioned between the seats 1221 and 1222 so that the display of the TV 1241 is visible to the passengers seated in the second row. A second 9-inch TV 1242 is positioned at the middle back of seats 1221, 1222 so that the display of the second TV 1242 is visible to the passengers seated in the third row of seats. Notwithstanding, the dimensions of the televisions 1241, 1242 are not so limited and television units 1241, 1242 can be of any other size that suits user need and/or preference, such that the same are comfortably visible to all of the passengers, either singularly or in tandem.

The second row or middle row also comprises a first hidden compartment 125 and the third row or rear row comprises a second hidden compartment 126 to allow the passengers to keep any personal items and small bags hidden from sight. The rear end of the novel vehicle 100 further comprises a relatively deep trunk 127 to accommodate luggage of multiple passengers. The deep trunk 127 is a storage compartment that is spacious enough to store the luggage of more than four passengers. The size of the trunk 127 can easily accommodate the luggage of families travelling on long road trips.

FIG. 2 illustrates a top perspective view of another potential embodiment of the vehicle 100 with enhanced entertainment and storage options of the present invention in accordance with the disclosed architecture, wherein the vehicle 100 is comprised of a moonroof 128 and a plurality of rear hinged or “suicide” doors. As shown, the four suicide doors include a front left door 1161, a front right door 1162, a rear left door 1171 and a rear right door 1172. The front doors 1161 and 1162 are pivotally attached at the front-end side of the seats of the first row, and the rear doors 1171 and 1172 are pivotally attached at the rear end side of the seats of the second row, thereby making them what is commonly referred to as “suicide doors.”

The moonroof 128 has a structure similar to a sunroof with a tinted glass panel at the top of the vehicle 100. The moonroof 128 further comprises a window structure that can open and closed as per the driver and passengers' requirements. The moonroof 128 adds to the aesthetic look of the vehicle 100, and enables the passengers to enjoy the scenic beauty at night through the roof, thereby enriching the overall driving and traveling experience. The glass panel of the moon roof 128 may also be tiltable to direct a fresh breeze of outside air to enter the interior portion of the vehicle 100 when the vehicle is in motion. Additionally, or optionally, the moonroof 128 may include an interior sliding shade/panel that gives an option to the passengers to block outside light from entering the vehicle as per the wants and needs of the user.

The driver and passenger who are seated in the first-row seats 1211, 1212 can easily enter and exit the novel vehicle 100 by opening the doors 1161, 1162 respectively. Likewise, the passengers seated in the second row or middle row seats 1221, 1222 can enter and exit the novel vehicle 100 by opening either set of front doors 1161, 1162 or the rear doors 1171, 1172, respectively. The passengers seated in the rear row or third row seats can also use the rear doors 1171, 1172 for entering and exiting the novel vehicle 100.

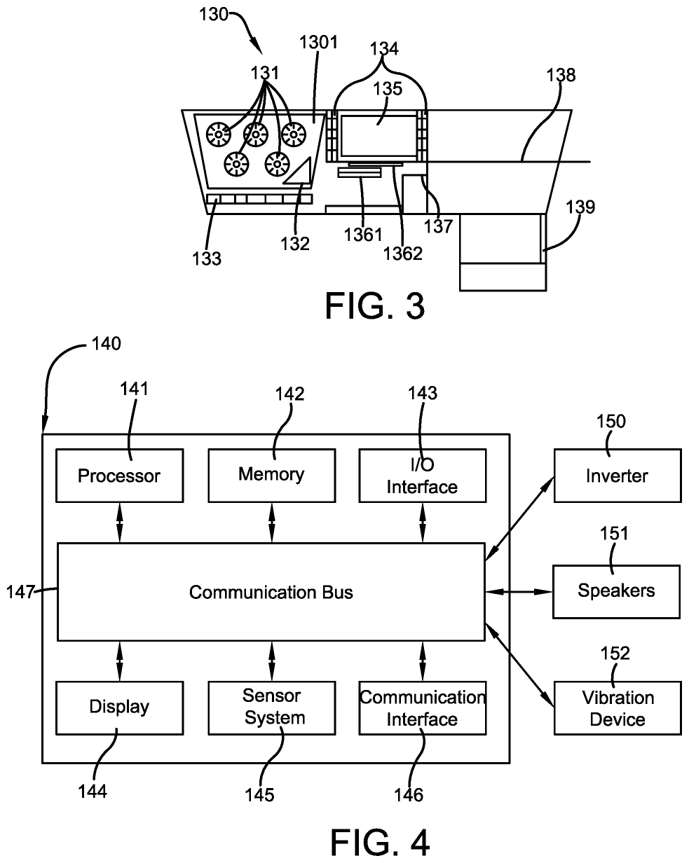

FIG. 3 illustrates a perspective view of one potential embodiment of the interior dashboard 130 of the vehicle 100 with enhanced entertainment and storage options of the present invention in accordance with the disclosed architecture. More specifically, the dashboard assembly 130 of the novel vehicle 100 of the present invention includes an instrument display panel 1301 that is usually located in-line with the steering wheel 121 shown in FIG. 1, which displays the instrumentation and controls for the vehicle's operation. The dashboard 130 features a set of instruments 131, such as a speedometer, odometer, tachometer and others. Additionally, the instruments 131 may include turn signal indicators, gearshift position indicator, seat belt warning light, parking-brake warning light, air-bag warning light, engine-malfunction lights, etc. The features included on the instrument display panel 1301 are not limited to current technology, since other instruments 131 can also be used for providing additional assistance to the driver of the car. The speedometer may indicate the speed of the vehicle 100 and the odometer may be used to record the miles traveled by the vehicle 100.

The instrument display panel 1301 also includes a gas gauge 132, which is an instrument used to indicate the amount of gasoline remaining in the vehicle's fuel tank, one or more attention lights 133 that can be used as warning lights signaling a mechanical problem with the vehicle such as overheating of the engine, control switches 134 for controlling some specific electrical circuitry within the vehicle, a seven-inch display monitor 135 providing touch screen to regulate the entertainment features, a tape player (or other media device) 1361, a CD/DVD player 1362, an iPod/MP3 player connector 137, a side panel 138, and a drop glove compartment 139. The components and their position on the dashboard 130 are shown in a preferable configuration, however other configurations can be designed while considering the comfort of both driver and passengers travelling in the vehicle 100.

FIG. 4 illustrates a diagrammatic view of one potential embodiment of the electronic components of the electronic/entertainment system 140 of the vehicle 100 with enhanced entertainment and storage options of the present invention in accordance with the disclosed architecture. As shown, the electronic system 140 of the novel vehicle 100 comprises a communication bus 147, a processor (e.g., including processing circuitry) 141, a memory module 142, an input/output interface (e.g., including input/output circuitry) 143, a display system (e.g., including display circuitry) 144, a sensor system 145, and a communication interface (e.g., including communication circuitry) 146. In an embodiment of the present invention, the novel electronic system 140 can be made with fewer constituent elements or additional constituent elements not shown. The communication bus 147 can, for example, include a circuit to connect the constituent elements 141 to 146 thereby establishing communication between the two constituent elements.

The electronic system 140 may further include components such as a security system, a global positioning system, hands-free telephone, advanced driver-assistance systems, air conditioning system and others. The vehicle 100 may include one or more USB ports located throughout the interior of the novel vehicle 100 so that passengers can charge their electronic devices while travelling in the vehicle 100. All these components may be connected to the communication bus 147 for performing various operations in the vehicle 100. The components of electronic system 140 are not limited and many other components may be included as per the desires of the users and manufacturers.

In a preferred embodiment of the present invention, the novel vehicle 100 includes a voltage inverter device 150 that uses low voltage electrical power generated by the vehicle and then inverted into high voltage alternating current for powering one or more accessories, such as the televisions, laptop computers, and video gaming systems. The audio from any of the multi-media devices within the novel vehicle 100 can be sent to one or more speakers 151 within the vehicle 100 or be locally broadcasted to an individual passenger via a pair of ear buds or a headset. The audio and video played through the multi-media devices are envisioned to comprise various pre-recorded content, such as but not limited to: music, calming nature sounds, poems, news, stories, nursery rhymes, animal sounds, movies, serials and the like. The audio and video are to be received from one or more multi-media devices that include microprocessor-based circuitry providing common memory and digital sound conversion functions, which are integral to the electric system 140.

In another embodiment of the present invention, the novel vehicle 100 may further include a vibration means or device 152 built within the vehicle seats that is capable of producing vibrations with varying frequencies and amplitudes. The vibration means 152 can operate in a synchronous manner whereby the aforementioned sound of the audio device is synchronized to the vibrations, which can enhance the entertainment of the passengers. Furthermore, the vibration means can also operate in a standalone mode, thereby providing a soothing vibration to comfort the passengers and/or to encourage them to relax and go to sleep.

Certain terms are used throughout the following description and claim to refer to particular feature or component. As one skilled in the art will appreciate, different persons may refer to the same feature or component by different names. This document does not intend to distinguish between components or features that differ in name but not structure or function. As used herein “car” and “vehicle” are interchangeable and refer to any transport means used primarily by the family or a group of people.

Notwithstanding the forgoing, the vehicle 100 of the present invention and its various structural components can be of any suitable size, shape, color, style and configuration as is known in the art without affecting the overall concept of the invention, provided that it accomplishes the above stated objectives. One of ordinary skill in the art will appreciate that the shape and size of the vehicle 100 and its various components, as shown in the FIGS. are for illustrative purposes only, and that many other shapes and sizes of the vehicle 100 are well within the scope of the present disclosure. Although the dimensions of the vehicle 100 and its components i.e., length, width, and height are important design parameters for good performance, the vehicle 100 of the present invention and its components may be of any shape, size, color and style that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle with enhanced entertainment and storage options, the vehicle comprising:
a first row of seats;
a second row of seats;
a third row of seats;
a plurality of suicide doors;
a first hidden compartment;
a second hidden compartment;
a first television set; and
a second television set.

2. The vehicle with enhanced entertainment and storage options as recited in claim 1 further comprising a moonroof.

3. The vehicle with enhanced entertainment and storage options as recited in claim 2 further comprising an inverter.

4. The vehicle with enhanced entertainment and storage options as recited in claim 3 further comprising a vibration device.

5. The vehicle with enhanced entertainment and storage options as recited in claim 4, wherein the vibration device is positioned beneath each of the first, second and third row of seats.

6. The vehicle with enhanced entertainment and storage options as recited in claim 5, wherein the first row of seats comprises a driver's seat and a front passenger seat.

7. The vehicle with enhanced entertainment and storage options as recited in claim 6, wherein the second row of seats comprises a first middle row passenger seat and a second middle row passenger seat, and further wherein the first hidden compartment is positioned between the first middle row passenger seat and the second middle row passenger seat.

8. The vehicle with enhanced entertainment and storage options as recited in claim 7, wherein the third of seats comprises a first passenger seat, a second passenger seat, a third passenger seat and a fourth passenger seat.

9. The vehicle with enhanced entertainment and storage options as recited in claim 8, wherein the first passenger seat, the second passenger seat, the third passenger seat and a the fourth passenger seat form an arc-like configuration.

10. The vehicle with enhanced entertainment and storage options as recited in claim 9, wherein the second hidden compartment is positioned between the first and fourth passenger seats.

11. The vehicle with enhanced entertainment and storage options as recited in claim 10, wherein the second hidden compartment is positioned between the second and third passenger seats.

12. The vehicle with enhanced entertainment and storage options as recited in claim 9, wherein the second hidden compartment is positioned between the first and second passenger seats.

13. The vehicle with enhanced entertainment and storage options as recited in claim 10, wherein the first television set is positioned between the first middle row passenger seat and the second middle row passenger seat.

14. A vehicle with enhanced entertainment and storage options, the vehicle comprising:
a first row of seats;
a second row of seats;
a third row of seats, wherein the third row of seats form an arc;
at least two suicide doors each having a rearward hinge;
a first hidden compartment positioned beneath the second row of seats;
a second hidden compartment positioned beneath the third row of seats;
a first television set; and
a second television set.

15. The vehicle with enhanced entertainment and storage options as recited in claim 14 further comprising a moonroof.

16. The vehicle with enhanced entertainment and storage options as recited in claim 15 further comprising an inverter.

17. The vehicle with enhanced entertainment and storage options as recited in claim 16 further comprising a vibration device.

18. The vehicle with enhanced entertainment and storage options as recited in claim 17, wherein the vibration device is positioned beneath each of the first, second and third row of seats.

19. The vehicle with enhanced entertainment and storage options as recited in claim 18, wherein the first television set is positioned along the second row of seats.

20. A vehicle with enhanced entertainment and storage options, the vehicle comprising:
a first row of seats;
a second row of seats;
a third row of seats, wherein the third row of seats form an arc;
at least two suicide doors each having a rearward hinge;
a first hidden compartment positioned beneath the second row of seats;
a second hidden compartment positioned beneath the third row of seats;
a first television set;
a second television set;
a communication bus;
a communication interface; and
a sensor system.
